(19) United States
(12) Patent Application Publication
(10) Pub. No.: US 2017/0008064 A1
(43) Pub. Date: Jan. 12, 2017

(54) COILING APPARATUS AND METHOD

(71) Applicant: HARRISON SPINKS COMPONENTS LIMITED, Leeds West Yorkshire (GB)

(72) Inventors: David CLARE, Barnsley, South Yorkshire (GB); Simon Paul SPINKS, Cawood, Yorkshire (GB); Richard ESSERY, Leeds, West Yorkshire (GB); Michael GALLAGHER, Leeds, West Yorkshire (GB)

(73) Assignee: HARRISON SPINKS COMPONENTS LIMITED, Leeds West Yorkshire (GB)

(21) Appl. No.: 15/115,451

(22) PCT Filed: Jan. 30, 2015
(86) PCT No.: PCT/GB2015/050235

§ 371 Date: Jul. 29, 2016

(30) Foreign Application Priority Data
Jan. 30, 2014 (GB) 1401597.8

(51) Int. Cl. B21F 3/02; B21F 35/00; B68G 9/00; B21F 23/00

(52) U.S. Cl. CPC B21F 3/02; B21F 23/00; B21F 35/00; B68G 9/00

(57) ABSTRACT

A wire supply station comprises a container 34 in which the wire is retained in a multitude of loops (not shown) of substantially the same diameter around a cylindrical inside surface of the drum. The wire 16 emerges from the drum 34 under no tension and substantially straight. It is then fed between guide or feed rollers 20 into the coiling head 12.

The wire 16 is formed into a continuous coil, from which lengths are cut by a cutter (not shown) to form individual coil springs 24. The individual coil springs 24 are then carried by the spring transfer station 26 to the fabric pocket welding station 28 where they become encased in individual pockets when the welding heads 30 weld the material.

Pre-straightening the wire before storing it in loops inside the cylindrical drum 34 allows for a more consistent pocket spring, and ultimately a flatter spring unit/mattress as any pre-stressing of the wire, caused by the drawing process used to manufacture it, is neutralised leaving the wire largely stress-free. This means that there is no need to compensate for, or break, the forces inherent in the wire before feeding it to the coiler. Accordingly the accumulator is not necessary and the wire supply can be positioned together with the coiling device, preferably above or below the coiling device, to take up less footprint in the factory.

The present invention relates to a coiling apparatus and to a method of coiling.

Coiling machines are used to coil wire, for example to form coil springs, which may be used in upholstered units such as mattresses. A coiling machine comprises input guide rollers, a wire pathway, a coiling head and an output portion.

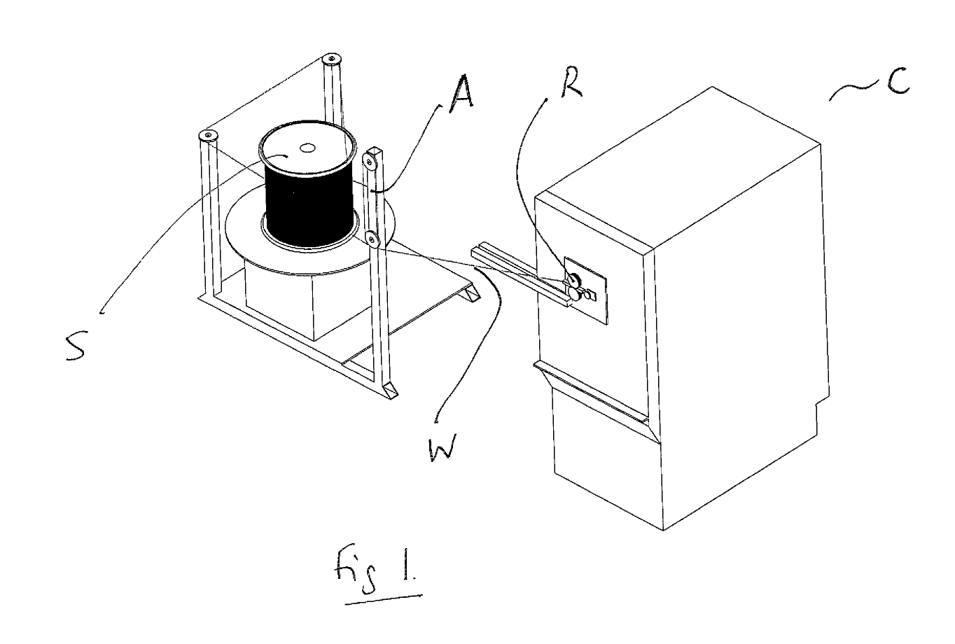

FIG. 1 shows a previously considered wire supply to a coiling machine. The coiling machine is shown generally at C, with input guide rollers R. Metal wire W is supplied from a spool S, on which the wire is wound. Because of the considerable weight of the wire on the spool the spool must be driven by a spool drive motor (not shown), and in order to maintain a near-zero tension in the wire entering the input guide rollers R the wire must pass through an accumulator A comprising a servo, which controls the spool drive motor. To accommodate this arrangement, which is common in the prior art, requires that the spool and accumulator be located off to the side of the coiling machine as shown in FIG. 1.

The wire W on spool S has a residual stress due to the effects of metal memory, and the method of manufacture in which the wire is drawn and rolled. The accumulator must maintain the wire in a predetermined orientation so that it is always presented to the input guide rollers correctly, to avoid kinking of the wire in the coiling machine which would cause rejection of the springs.

Typically this previously considered facility requires a substantial footprint in a factory, which limits the potential for incorporating coiling machines in the production lines of factories producing upholstered units.

Embodiments of the present invention aim to address the shortcomings of the prior art.

The present invention is defined in the attached independent claims, to which reference should now be made. Further, preferred features may be found in the sub-claims appended thereto.

According to one aspect of the present invention, there is provided coiling apparatus for forming coils from a length of wire, the apparatus comprising a coiling device for shaping wire into coils and cutting coils from the length of wire, wherein wire is provided to the coiling device from a wire supply station, and wherein the wire supply station is located generally vertically above or below at least a part of the coiling device.

According to another aspect of the present invention, there is provided coiling apparatus for forming coils from a length of wire, the apparatus comprising a coiling device for shaping wire into coils and cutting coils from the length of wire, wherein wire is provided to the coiling device from a wire supply station, and wherein the wire supply station comprises a container with wire wound around an interior thereof in a plurality of loops.

At least a majority of the loops of wire are preferably of substantially the same diameter. In a preferred arrangement, the container is generally cylindrical.

According to another aspect of the present invention, there is provided coiling apparatus for forming coils from a length of wire, the apparatus comprising a coiling device for shaping wire into coils and cutting coils from the length of wire, wherein wire is provided to the coiling device from a wire supply station, through at least one pair of input guide and/or feed rollers that have axes in a common, generally horizontal plane.

According to a further aspect of the invention there is provided a wire supply station for supplying wire to a wire handling apparatus, wherein the wire supply station is arranged in use to be located generally vertically above or below at least a part of the wire-handling device.

According to a still further aspect of the present invention, there is provided a wire supply station, for supplying wire to a wire handling apparatus, wherein the wire supply station comprises a container with wire wound around an interior thereof in a plurality of loops.

According to a yet further aspect of the present invention, there is provided a wire supply station, for supplying wire to a wire handling apparatus, wherein the wire supply station is arranged to supply the wire handling device with wire such that the wire passes through at least one pair of input guide and/or feed rollers that have axes in a common, generally horizontal plane.

The wire handling apparatus may comprise a coiling device.

In a preferred arrangement the wire is supplied to the coiling device under substantially no tension.

Preferably the wire is supplied to the coiling device substantially straight.

According to another aspect of the present invention, there is provided a method of supplying wire to a wire handling apparatus, the method comprising providing the wire to the wire handling apparatus from a wire supply station located generally vertically above or below at least a part of the wire handling apparatus.

The invention also includes a method of providing wire to a wire handling apparatus, the method comprising providing the wire to the wire handling apparatus from a wire supply station comprising a container containing wire wound around an interior thereof in a plurality of loops.

The invention also includes a method of supplying wire to a wire handling apparatus, the method comprising providing the wire to the wire handling apparatus from a wire supply station, through at least one pair of input guide/feed rollers that have axes in a common, generally horizontal plane.

The invention also includes a method of providing wire to a wire handling apparatus, the method comprising supplying pre-straightened, drum coiled wire to the wire handling apparatus.

The method may comprise providing wire to a wire handling apparatus comprising a coiling device for producing coils of wire.

The invention also includes a method of manufacturing a pocketed spring unit, the method comprising supplying pre-straightened, drum coiled wire to a coiling device, coiling the wire in the coiling device to form a plurality of springs, and encasing the springs in material to form a plurality of pocketed springs.

The invention may include any combination of the features or limitations referred to herein, except such a combination of features as are mutually exclusive, or mutually inconsistent.

A preferred embodiment of the present invention will now be described. By way of example only, with reference to the accompanying diagrammatic drawings, in which:

FIG. 1 shows in perspective view a coiling apparatus according to the prior art;

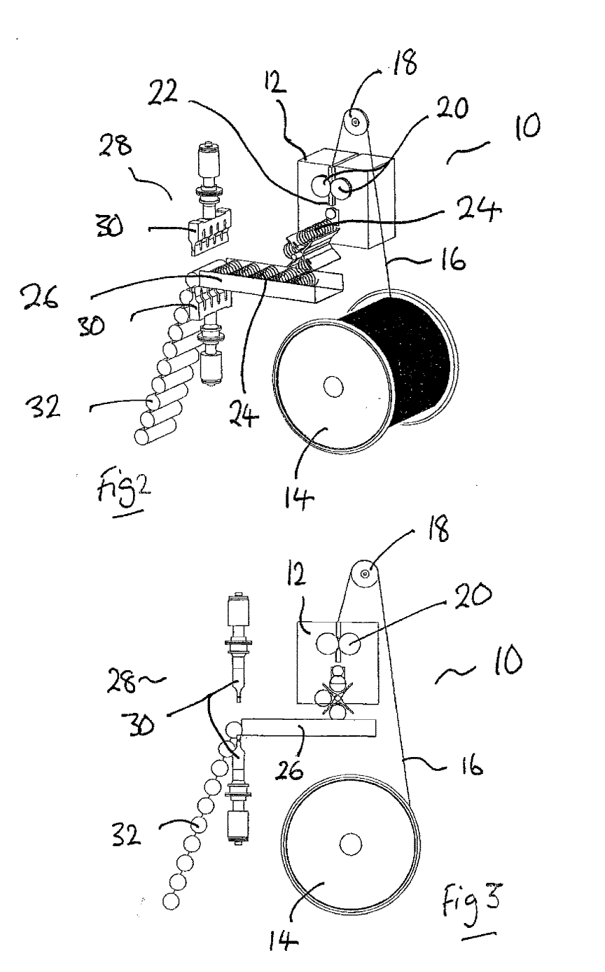

FIG. 2 shows schematically in perspective view a coiling apparatus according to a first embodiment of the present invention;

FIG. 3 shows the apparatus of FIG. 2 in side view;

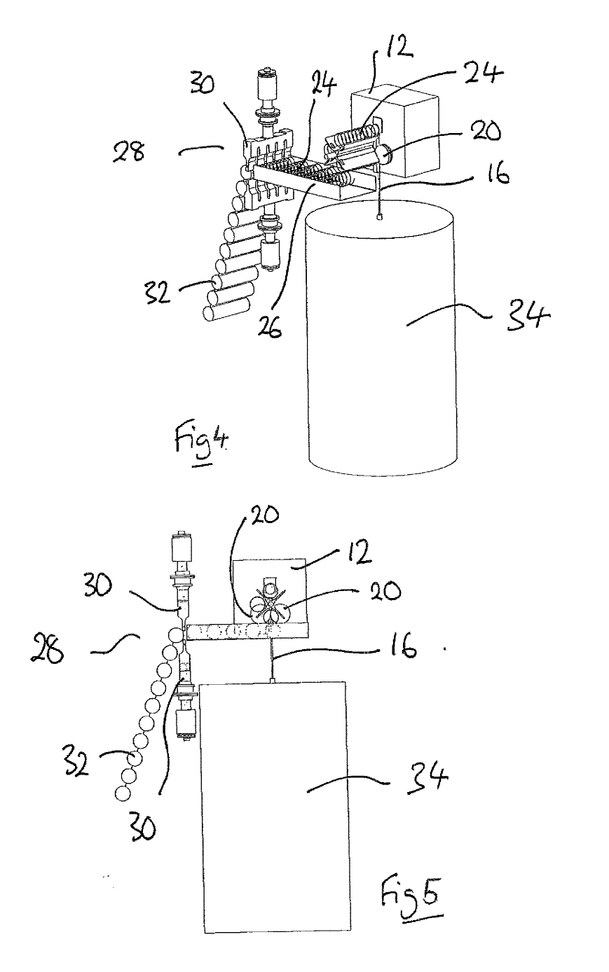

FIG. 4 shows schematically in perspective view a coiling apparatus according to a second embodiment of the present invention;

FIG. 5 shows the apparatus of FIG. 4 in side view;

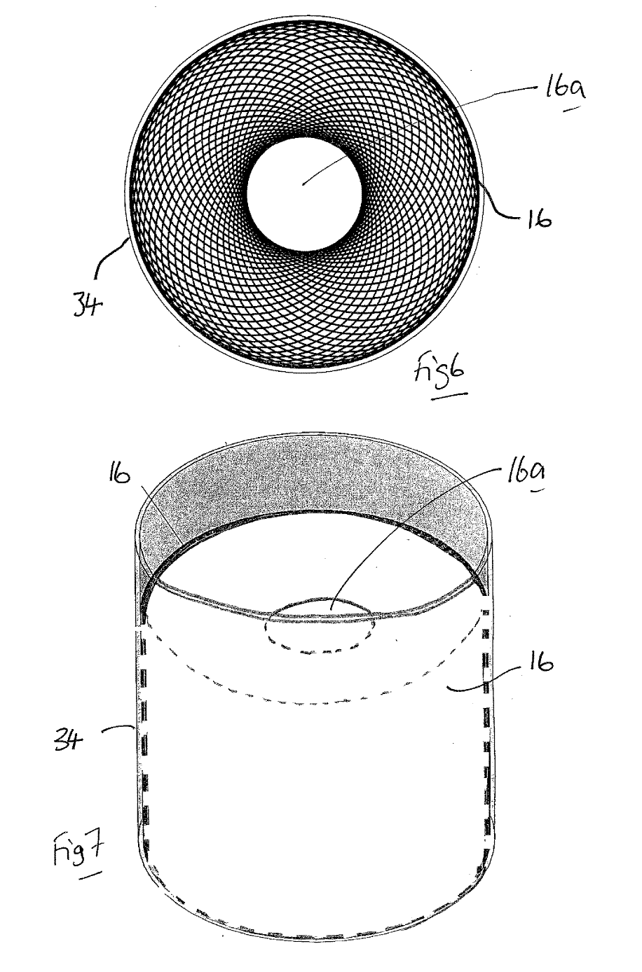

FIG. 6 shows in schematic plan view a drum of pre-straightened wire; and

FIG. 7 shows the drum of FIG. 6 in schematic, perspective view.

Turning to FIGS. 2 and 3, these show a first embodiment of coiling apparatus generally at 10. The apparatus comprises a coiling device 12 and, substantially vertically below the device 12, a wire supply station, in the form of a spool 14 of wire. Wire 16 is fed from the spool 14 via a first roller 18 and then between a pair of input guide rollers 20, whose axes share a common, substantially horizontal plane. The wire 16 passes through rollers 20 into a coiling head 22, where it is formed into a continuous coil, from which lengths are cut by a cutter (not shown) to form individual coil springs 24. The individual coil springs 24 are then deposited on a spring transfer station 26 on which they travel a short distance to a fabric pocket welding station 28 where fabric material is introduced from rollers (omitted from the drawing for clarity). Each spring becomes encased in an individual pocket as welding heads 30 weld the material along a seam extending axially of the spring to form a pocketed spring 32.

The position of the wire supply station below the coiling device minimises the overall footprint of the apparatus 10, when compared with previously considered apparatus of this kind.

Turning to FIGS. 4 and 5, these show an alternative embodiment. In the embodiment of FIGS. 4 and 5, identical or equivalent items to those in FIGS. 2 and 3 are labeled identically. In this embodiment the wire supply station comprises a container 34 in which the wire is retained in a multitude of loops (not shown) of substantially the same diameter around a cylindrical inside surface of the drum. The wire 16 emerges from the drum 34 under no tension and substantially straight. It is then fed between guide and/or feed rollers 20 into the coiling head 12.

As with the previous embodiment, the wire 16 is formed into a continuous coil, from which lengths are cut by a cutter (not shown) to form individual coil springs 24. The individual coil springs 24 are then carried by the spring transfer station 26 to the fabric pocket welding station 28 where they become encased in individual pockets when the welding heads 30 weld the material.

FIGS. 6 and 7 show, respectively in plan and in perspective views, the drum 34 with the wire 16 coiled therein. In FIG. 7 the coil is shown partly in broken lines within the drum 34. To load the drum 34, a machine head (not shown) places successive coils within the drum as the drum rotates. The head is offset with respect to the centre of the drum so that the coils are laid in an offset configuration that proceeds around the interior of the drum wall, building up the layers of wire upon previous layers to form the pattern shown in FIG. 6. A void 16a is left in the centre of the loaded drum.

Pre-straightening the wire before storing it in loops inside the cylindrical drum 34 allows for a more consistent pocket spring, and ultimately a flatter spring unit/mattress as any pre-stressing of the wire, caused by the drawing process used to manufacture it, is neutralised leaving the wire largely stress-free. This means that there is no need to compensate for, or break, the forces inherent in the wire before feeding it to the coiler. Accordingly the accumulator is not necessary and the wire supply can be positioned together with the coiling device, preferably above or below the coiling device, to take up less footprint in the factory.

Another possibility is to store the wire remotely from the coiler and to feed the wire to the coiler from any appropriate direction. This would allow, for example, the feeding of wire from a central stock location.

Whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

1. A coiling apparatus for forming coils from a length of wire, the apparatus comprising a coiling device for shaping wire into coils and cutting coils from the length of wire, wherein wire is provided to the coiling device from a wire supply station, and wherein the wire supply station comprises a container with wire wound around an interior thereof in a plurality of loops.

2. The coiling apparatus according to claim 1, wherein at least a majority of the loops of wire are preferably of substantially the same diameter. In a preferred arrangement, the container is generally cylindrical.

3. The coiling apparatus according to claim 1, wherein the wire supply station is located generally vertically above or below at least a part of the coiling device.

4. The coiling apparatus according to claim 1, wherein the wire is provided to the coiling device from the wire supply station through at least one pair of input guide/feed rollers that have axes in a common, generally horizontal plane.

5. A wire supply station for supplying wire to a wire handling apparatus, wherein the wire supply station is arranged in use to be located generally vertically above or below at least a part of the wire-handling apparatus.

6. The wire supply station according to claim 5, wherein the wire supply station comprises a container with wire wound around an interior thereof in a plurality of loops.

7. The wire supply station according to claim 5, wherein the wire supply station is arranged to supply the wire handling device with wire such that the wire passes through at least one pair of input guide/feed rollers that have axes in a common, generally horizontal plane.

8. The wire supply station according to claim 5, wherein the wire handling apparatus comprises a coiling device.

9. The wire supply station according to claim 5, wherein wire is arranged to be supplied to the coiling device under substantially no tension.

10. The wire supply station according to claim 5, wherein wire is arranged to be supplied to the coiling device in a substantially pre-straightened configuration.

11. A method of providing wire to a wire handling apparatus, the method comprising providing the wire to the wire handling apparatus from a wire supply station comprising a container containing wire wound around an interior thereof in a plurality of loops.

12. The method of supplying wire to a wire handling apparatus according to claim 11, wherein the wire supply station is located generally vertically above or below at least a part of the wire handling apparatus.

13. The method of supplying wire to a wire handling apparatus according to claim 11, the wire is provided to the wire handling apparatus from the wire supply station, through at least one pair of input guide/feed rollers that have axes in a common, generally horizontal plane.

14. The method of supplying wire to a wire handling apparatus according to claim 11, wherein the method further includes the step of supplying pre-straightened, drum coiled wire to the wire handling apparatus.

15. The method according to claim 11, wherein the step of providing wire to the wire handling apparatus includes the step of producing coils of wire using a coiling device.

16. A method of manufacturing a pocketed spring unit, the method comprising supplying pre-straightened, drum coiled wire to the coiling apparatus of claim 1, and encasing the springs in material to form a plurality of pocketed springs.

17. The coiling apparatus according to claim 1, wherein wire is arranged to be supplied to the coiling device under substantially no tension.

18. The coiling apparatus according to claim 1, wherein wire is arranged to be supplied to the coiling device in a substantially pre-straightened configuration.
